(19) United States
(12) Patent Application Publication
(10) Pub. No.: US 2006/0142486 A1
(43) Pub. Date: Jun. 29, 2006

(54) Thermoplastic polycarbonate compositions, articles made therefrom and method of manufacture

(76) Inventors: James Louis DeRudder, Mt. Vernon, IN (US); Robert Walter Venderbosch, Bergen op Zoom (NL); Andries Adriaan Volkers, Wouw (NL)

Correspondence Address: CANTOR COLBURN, LLP, 55 GRIFFIN ROAD SOUTH, BLOOMFIELD, CT, 06002, US

(21) Appl. No.: 11/020,924

(22) Filed: Dec. 23, 2004

(51) Int. Cl. C08F 8/00; C08K 5/34; C08L 51/04

(52) U.S. Cl. 525/71; 524/106; 525/100

(57) ABSTRACT

A thermoplastic composition made from a polycarbonate resin, bulk polymerized ABS, and a polycarbonate-polysiloxane copolymer, wherein a 4-mm thick molded INI bar comprising the composition has an initial (before aging) notched Izod impact strength of at least about 36 kJ/m2 determined in accordance with ISO 180/1A at −40° C. An article may be made from such a composition. The article may be formed by molding, shaping or forming the composition to form the article.

### BACKGROUND

This invention is directed to thermoplastic compositions comprising aromatic polycarbonate, and in particular impact-modified thermoplastic polycarbonate compositions having improved stability.

Aromatic polycarbonates are useful in the manufacture of articles and components for a wide range of applications, from automotive parts to electronic appliances. Impact modifiers are commonly added to aromatic polycarbonates to improve the toughness of the compositions. The impact modifiers often have a relatively rigid thermoplastic phase and an elastomeric (rubbery) phase, and may be formed by bulk or emulsion polymerization. Polycarbonate compositions comprising acrylonitrile-butadiene-styrene (ABS) impact modifiers are described generally, for example, in U.S. Pat. No. 3,130,177. Polycarbonate compositions comprising emulsion polymerized ABS impact modifiers are described in particular in U.S. Publication No. 2003/0119986. U.S. Publication No. 2003/0092837 discloses use of a combination of a bulk polymerized ABS and an emulsion polymerized ABS.

Of course, a wide variety of other types of impact modifiers for use in polycarbonate compositions have also been described. While suitable for their intended purpose of improving toughness, many impact modifiers may also adversely affect other properties, such as processability, heat stability, hydrolytic stability, and/or low temperature impact strength, particularly upon prolonged exposure to high humidity and/or high temperature such may be found in Southeast Asia. Hydrolytic aging stability of polycarbonate compositions, in particular, is often degraded with the addition of rubbery impact modifiers. There remains a continuing need in the art, therefore, for impact-modified thermoplastic polycarbonate compositions having a combination of good properties, including toughness and hydrolytic stability. It would further be advantageous if hydrolytic stability could be improved without significantly adversely affecting other desirable properties of polycarbonates.

### SUMMARY OF THE INVENTION

A thermoplastic composition comprises a polycarbonate resin, bulk polymerized ABS, and a polycarbonate-polysiloxane copolymer, wherein a 4-mm thick molded INI bar comprising the composition has an initial (before aging) notched Izod impact strength of at least about 36 kJ/m2 determined in accordance with ISO 180/1A at −40° C.

An article may comprise such a composition.

The article may be formed by molding, shaping or forming the composition to form the article.

### DETAILED DESCRIPTION OF THE INVENTION

Thermoplastic compositions comprising polycarbonate-polysiloxane copolymer, bulk acrylonitrile-butadiene-styrene and polycarbonate polymeric materials exhibit good physical properties such as thermal stability, low temperature impact resistance, and good hydrolytic stability, providing combinations of properties are difficult to attain in polycarbonate-containing polymeric materials.

As used herein, the terms “polycarbonate” and “polycarbonate resin” means compositions having repeating structural carbonate units of formula (1): 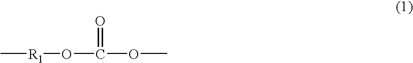
in which at least about 60 percent of the total number of R¹ groups are aromatic organic radicals and the balance thereof are aliphatic, alicyclic, or aromatic radicals. In one embodiment each R¹ is an aromatic organic radical and, more specifically, a radical of formula (2):
-A¹-Y¹-A²- (2)
wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexylmethylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)
HO-A¹-Y¹-A²-OH (3)
wherein Y¹, A¹ and A² are as described above. Also included are bisphenol compounds of general formula (4): 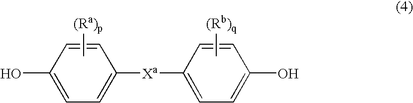
wherein R^{a} and R^{b} each represent a halogen atom or a monovalent hydrocarbon group and may be the same or different; p and q are each independently integers of 0 to 4; and X^{a} represents one of the groups of formula (5): 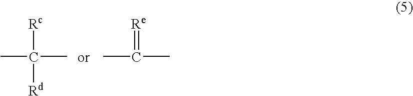
wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl) methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy compounds.

A nonexclusive list of specific examples of the types of bisphenol compounds that may be represented by formula (3) includes 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, and 1,1-bis(4-hydroxy-t-butylphenyl) propane. Combinations comprising at least one of the foregoing dihydroxy compounds may also be used.

Branched polycarbonates are also useful, as well as blends comprising a linear polycarbonate and a branched polycarbonate. The branched polycarbonates may be prepared by adding a branching agent during polymerization, for example a polyfunctional organic compound containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 wt. % to 2.0 wt. %. All types of polycarbonate end groups are contemplated as being useful in the polycarbonate composition, provided that such end groups do not significantly affect desired properties of the thermoplastic compositions.

Suitable polycarbonates can be manufactured by processes such as interfacial polymerization or melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about pH 8 to about pH 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors may also be used.

Among the exemplary phase transfer catalysts that may be used are catalysts of the formula (R³)₄Q⁺X, wherein each R³ is the same or different, and is a Cl₁₋₁₀ alkyl group; Q is a nitrogen or phosphorus atom; and X is a halogen atom or a C₁₋₈ alkoxy group or C₆₋₁₈₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX wherein X is Cl⁻, Br⁻, a C₁₋₈ alkoxy group or C₆₋₁₈₈ aryloxy group. An effective amount of a phase transfer catalyst may be about 0.1 to about 10 wt. % based on the weight of bisphenol in the phosgenation mixture. In another embodiment an effective amount of phase transfer catalyst may be about 0.5 to about 2 wt. % based on the weight of bisphenol in the phosgenation mixture.

Alternatively, melt processes may be used. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst. Volatile monohydric phenol is removed from the molten reactants by distillation and the polymer is isolated as a molten residue.

“Polycarbonate” and “polycarbonate resin” as used herein further includes copolymers comprising carbonate chain units together with a different type of chain unit. Such copolymers may be random copolymers, block copolymers, dendrimers or the like. One specific type of copolymer that may be used is a polyester carbonate, also known as a copolyester-polycarbonate. Such copolymers further contain, in addition to recurring carbonate chain units of the formula (1), repeating units of formula (6) 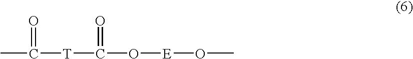
wherein E is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, E is a C₂₋₆ alkylene radical. In another embodiment, E is derived from an aromatic dihydroxy compound of formula (7): 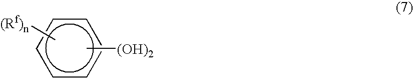
wherein each R^{f} is independently a halogen atom, a C₁₋₁₀ hydrocarbon group, or a C₁₋₁₀ halogen substituted hydrocarbon group, and n is 0 to 4. The halogen is preferably bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is about 10:1 to about 0.2:9.8. In another specific embodiment, E is a C₂₋₆ alkylene radical and T is p-phenylene, m-phenylene, naphthalene, a divalent cycloaliphatic radical, or a mixture thereof. This class of polyester includes the poly(alkylene terephthalates).

In one specific embodiment, the polycarbonate is a linear homopolymer derived from bisphenol A, in which each of A¹ and A² is p-phenylene and Y¹ is isopropylidene. The polycarbonates may have an intrinsic viscosity, as determined in chloroform at 25° C., of about 0.3 deciliters per gram (dl/gm) to about 1.5 dl/gm, specifically about 0.45 dl/gm to about 1.0 dl/gm. The polycarbonates may have a weight average molecular weight of about 10,000 grams per mole (g/mole) to about 200,000 g/mole, specifically about 20,000 g/mole to about 100,000 g/mole as measured by gel permeation chromatography. Preferably, the polycarbonate is substantially free of impurities, residual acids, residual bases, and/or residual metals that may catalyze the hydrolysis of polycarbonate.

The copolyester-polycarbonate resins are also prepared by interfacial polymerization. Rather than using the dicarboxylic acid per se, it is possible, and sometimes even preferred, to employ the reactive derivatives of the acid, such as the corresponding acid halides, in particular the acid dichlorides and the acid dibromides. Thus, for example instead of using isophthalic acid, terephthalic acid, and mixtures thereof, it is possible to employ isophthaloyl dichloride, terephthaloyl dichloride, and mixtures thereof.

In one embodiment, the polycarbonate is based on Bisphenol A, and may have a molecular weight of 10,000 g/mole to 120,000 g/mole, more specifically 18,000 g/mole to 40,000 g/mole (on an absolute molecular weight scale). Such polycarbonate materials are available from GE Advanced Materials under the trade name LEXAN. The initial melt flow of such polycarbonates may be about 6 to about 65 grams per 10 minutes flow (g/10 min) measured at 300° C. using a 1.2 Kg load.

The polycarbonate component may further comprise, in addition to the polycarbonates described above, combinations of the polycarbonates with other thermoplastic polymers, for example combinations of polycarbonate homopolymers and/or copolymers with polyesters. As used herein, a “combination” is inclusive of all mixtures, blends, alloys, and the like. Suitable polyesters comprise repeating units of formula (6), and may be, for example, poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end-use of the composition.

In one embodiment, poly(alkylene terephthalates) are used. Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters. Also contemplated herein are the above polyesters with a minor amount, e.g., from about 0.5 to about 10 percent by weight, of units derived from an aliphatic diacid and/or an aliphatic polyol to make copolyesters.

The blends of a polycarbonate and a polyester may comprise about 10 wt. % to about 99 wt. % polycarbonate and correspondingly about 1 wt. % to about 90 wt. % polyester, in particular a poly(alkylene terephthalate). In one embodiment, the blend comprises about 30 wt. % to about 70 wt. % polycarbonate and correspondingly about 30 wt. % to about 70 wt. % polyester. The foregoing amounts are based on the combined weight of the polycarbonate and polyester.

Although blends of polycarbonates with other polymers are contemplated, in various embodiments the polycarbonate resin, when blended with the other components of the compositions described herein, may contain polycarbonate homopolymers and/or polycarbonate copolymers and may be substantially free of polyester and, optionally, free of other types of polymeric materials blended with the polycarbonate composition.

The composition also comprises a polycarbonate-polysiloxane copolymer comprising polycarbonate blocks and polydiorganosiloxane blocks. The polycarbonate blocks in the copolymer comprise repeating structural units of formula (1) as described above, for example wherein R¹ is of formula (2) as described above. These units may be derived from reaction of dihydroxy compounds of formula (3) as described above. In one embodiment, the dihydroxy compound is bisphenol A, in which each of A¹ and A² is p-phenylene and Y¹ is isopropylidene.

The polydiorganosiloxane blocks of the copolymer comprise repeating structural units of formula (8) (sometimes referred to herein as siloxane units): 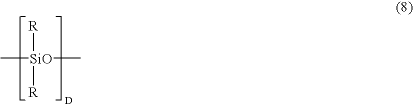
wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. The foregoing groups may be fully or partially halogenated with fluorine, chlorine, bromine, or iodine, or a combination thereof. Combinations of the foregoing R groups may be used in the same copolymer.

The value of D in formula (8) may vary widely depending on the type and relative amount of each component in the thermoplastic composition, the desired properties of the composition, and like considerations. Generally, D may have an average value of 2 to about 1,000, specifically about 2 to about 500, more specifically about 5 to about 100. In one embodiment, D has an average value of about 10 to about 75, and in still another embodiment, D has an average value of about 40 to about 60. Where D is of a lower value, e.g., less than about 40, it may be desirable to use a relatively larger amount of the polycarbonate-polysiloxane copolymer. Conversely, where D is of a higher value, e.g., greater than about 40, it may be necessary to use a relatively lower amount of the polycarbonate-polysiloxane copolymer.

A combination of a first and a second (or more) polycarbonate-polysiloxane copolymers may be used, wherein the average value of D of the first copolymer is less than the average value of D of the second copolymer.

In one embodiment, the polydiorganosiloxane blocks are provided by repeating structural units of formula (9): 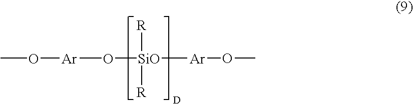
wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (9) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of suitable dihydroxyarlyene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulphide), and 1,1-bis(4-hydroxy-t-butylphenyl) propane. Combinations comprising at least one of the foregoing dihydroxy compounds may also be used.

Such units may be derived from the corresponding dihydroxy compound of the following formula: 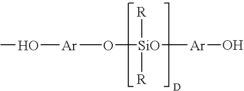
wherein Ar and D are as described above. Such compounds are further described in U.S. Pat. No. 4,746,701 to Kress et al. Compounds of this formula may be obtained by the reaction of a dihydroxyarylene compound with, for example, an alpha, omega-bisacetoxypolydiorangonosiloxane under phase transfer conditions.

In another embodiment, the polydiorganosiloxane blocks are provided by repeating structural units of formula (10) 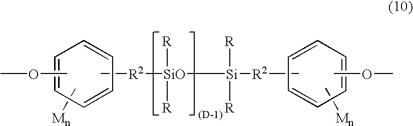
wherein R and D are as defined above. R² in formula (10) is a divalent C₂-C₈ aliphatic group. Each M in formula (9) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

Units of formula (10) may be derived from the corresponding dihydroxy polydiorganosiloxane (11): 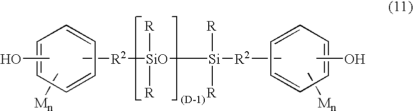
wherein R, D, M, R², and n are as described above. Such dihydroxy polysiloxanes can be made by effecting a platinum catalyzed addition between a siloxane hydride of the following formula 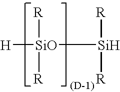
wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

The polycarbonate-polysiloxane copolymer may be manufactured by reaction of diphenolic polysiloxane (10) with a carbonate source and a dihydroxy aromatic compound of formula (3), optionally in the presence of a phase transfer catalyst as described above. Suitable conditions are similar to those useful in forming polycarbonates. For example, the copolymers are prepared by phosgenation, at temperatures from below 0° C. to about 100° C., preferably about 25° C. to about 50° C. Since the reaction is exothermic, the rate of phosgene addition may be used to control the reaction temperature. The amount of phosgene required will generally depend upon the amount of the dihydric reactants. Alternatively, the polycarbonate-polysiloxane copolymers may be prepared by co-reacting in a molten state, the dihydroxy monomers and a diaryl carbonate ester, such as diphenyl carbonate, in the presence of a transesterification catalyst as described above.

In the production of the polycarbonate-polysiloxane copolymer, the amount of dihydroxy polydiorganosiloxane is selected so as to provide the desired amount of polydiorganosiloxane units in the copolymer. The amount of polydiorganosiloxane units may vary widely, i.e., may be about 1 to about 99 wt. % of polydimethylsiloxane, or an equivalent molar amount of another polydiorganosiloxane, with the balance being carbonate units. The particular amounts used will therefore be determined depending on desired physical properties of the thermoplastic composition, the value of D (within the range of 2 to about 1,000), and the type and relative amount of each component in the thermoplastic composition, including the type and amount of polycarbonate, type and amount of impact modifier, type and amount of polycarbonate-polysiloxane copolymer, and type and amount of any other additives. Suitable amounts of dihydroxy polydiorganosiloxane can be determined by one of ordinary skill in the art without undue experimentation using the guidelines taught herein. For example, the amount of dihydroxy polydiorganosiloxane may be selected so as to produce a copolymer comprising about 1 wt. % to about 75 wt. %, or about 1 wt. % to about 50 wt. % of polydimethylsiloxane, or an equivalent weight or molar proportion of another polydiorganosiloxane. In one embodiment, the copolymer comprises about 5 wt. % to about 40 wt. %, optionally about 5 wt. % to about 25 wt. % polydimethylsiloxane, or an equivalent weight or molar proportion of another polydiorganosiloxane, with the balance being polycarbonate. In a particular embodiment, the copolymer may comprise about 20 wt. % siloxane. Optionally, the copolymer contains at least about 0.2 wt. %, optionally at least about 1 wt. % siloxane by weight of the copolymer plus polycarbonate plus bulk polymerized ABS in the composition, e.g., the composition may comprise 20 wt. % of a polycarbonate-polysiloxane copolymer that contains 5 wt. % siloxane, yielding 1 wt. % siloxane in the composition. The polycarbonate-polysiloxane copolymer may comprise at least about 1 wt. % of dimethylsiloxane, or a molar equivalent of another siloxane, based on the weight of polycarbonate-polysiloxane copolymer, bulk polymerized ABS and polycarbonate in the composition.

The polycarbonate-polysiloxane copolymers have a weight-average molecular weight (MW, measured, for example, by gel permeation chromatography, ultra-centrifugation, or light scattering) of about 10,000 g/mole to about 200,000 g/mole, specifically about 20,000 to about 100,000 g/mole.

The composition also comprises bulk polymerized ABS (BABS). Bulk polymerized ABS comprises an elastomeric phase comprising (i) butadiene and having a Tg of less than about 10° C., and (ii) a rigid polymeric phase comprising a copolymer of a monovinylaromatic monomer such as styrene and an unsaturated nitrile such as acrylonitrile. Such ABS polymers may be prepared by first providing the elastomeric polymer, then polymerizing the constituent monomers of the rigid phase in the presence of the elastomer to obtain the graft copolymer. The grafts may be attached as graft branches or as shells to an elastomer core. The shell may merely physically encapsulate the core, or the shell may be partially or substantially grafted to the core.

Polybutadiene homopolymer may be used as the elastomer phase. Alternatively, the elastomer phase of the bulk polymerized ABS comprises butadiene copolymerized with up to about 25 wt. % of another conjugated diene monomer of formula (12): 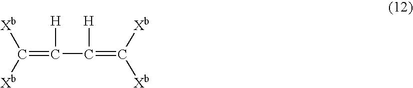
wherein each X^{b} is independently C₁-C₅ alkyl. Examples of conjugated diene monomers that may be used are isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. A specific conjugated diene is isoprene.

The elastomeric butadiene phase may additionally be copolymerized with up to 25 wt. %, specifically up to about 15 wt. %, of another comonomer, for example monovinylaromatic monomers containing condensed aromatic ring structures such as vinyl naphthalene, vinyl anthracene and the like, or monomers of formula (13): 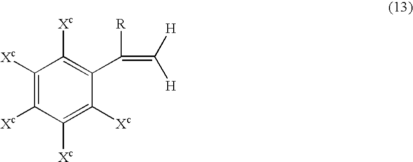
wherein each X^{c} is independently hydrogen, C₁-C₁₂ alkyl, C₃-C₁₂ cycloalkyl, C₆-C₁₂ aryl, C₇-C₁₂ aralkyl, C₇-C₁₂ alkaryl, C₁-C₁₂ alkoxy, C₃-C₁₂ cycloalkoxy, C₆-C₁₂ aryloxy, chloro, bromo, or hydroxy, and R is hydrogen, C₁-C₅ alkyl, bromo, or chloro. Examples of suitable monovinylaromatic monomers copolymerizable with the butadiene include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing monovinylaromatic monomers. In one embodiment, the butadiene is copolymerized with up to about 12 wt. % styrene and/or alpha-methyl styrene.

Other monomers that may be copolymerized with the butadiene are monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (14): 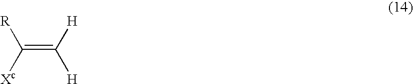
wherein R is hydrogen, C₁-C₅ alkyl, bromo, or chloro, and X^{c} is cyano, C₁-C₁₂ alkoxycarbonyl, C₁-C₁₂ aryloxycarbonyl, hydroxy carbonyl, or the like. Examples of monomers of formula (14) include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers. Monomers such as n-butyl acrylate, ethyl acrylate, and 2-ethylhexyl acrylate are commonly used as monomers copolymerizable with the butadiene.

The particle size of the butadiene phase is not critical, and may be, for example about 0.01 micrometers (μm) to about 20 μm, specifically about 0.5 μm to about 10 μm, more specifically about 0.6 μm to about 1.5 μm may be used for bulk polymerized rubber substrates. Particle size may be measured by light transmission methods or capillary hydrodynamic chromatography (CHDF). The butadiene phase may provide about 5 wt. % to about 95 wt. % of the total weight of the ABS impact modifier copolymer, more specifically about 20 wt. % to about 90 wt. %, and even more specifically about 40 wt. % to about 85 wt. % of the ABS impact modifier, the remainder being the rigid graft phase.

The rigid graft phase comprises a copolymer formed from a styrenic monomer composition together with an unsaturated monomer comprising a nitrile group. As used herein, “styrenic monomer” includes monomers of formula (13) wherein each X^{c} is independently hydrogen, C₁-C₄ alkyl, phenyl, C₇-C₉ aralkyl, C₇-C₉ alkaryl, C₁-C₄ alkoxy, phenoxy, chloro, bromo, or hydroxy, and R is hydrogen, C₁-C₂ alkyl, bromo, or chloro. Specific examples styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like. Combinations comprising at least one of the foregoing styrenic monomers may be used.

Further as used herein, an unsaturated monomer comprising a nitrile group includes monomers of formula (14) wherein R is hydrogen, C₁-C₅ alkyl, bromo, or chloro, and X^{c} is cyano. Specific examples include acrylonitrile, ethacrylonitrile, methacrylonitrile, alpha-chloroacrylonitrile, beta-chloroacrylonitrile, alpha-bromoacrylonitrile, and the like. Combinations comprising at least one of the foregoing monomers may be used.

The rigid graft phase of the bulk polymerized ABS may further optionally comprise other monomers copolymerizable therewith, including other monovinylaromatic monomers and/or monovinylic monomers such as itaconic acid, acrylamide, N-substituted acrylamide or methacrylamide, maleic anhydride, maleimide, N-alkyl-, aryl-, or haloaryl-substituted maleimide, glycidyl (meth)acrylates, and monomers of the generic formula (10). Specific comonomers include C₁-C₄ alkyl (meth)acrylates, for example methyl methacrylate.

The rigid copolymer phase will generally comprise about 10 wt. % to about 99 wt. %, specifically about 40 wt. % to about 95 wt. %, more specifically about 50 wt. % to about 90 wt. % of the styrenic monomer; about 1 wt. % to about 90 wt. %, specifically about 10 wt. % to about 80 wt. %, more specifically about 10 wt. % to about 50 wt. % of the unsaturated monomer comprising a nitrile group; and 0 to about 25 wt. %, specifically 1 wt. % to about 15 wt. % of other comonomer, each based on the total weight of the rigid copolymer phase.

The bulk polymerized ABS copolymer may further comprise a separate matrix or continuous phase of ungrafted rigid copolymer that may be simultaneously obtained with the bulk polymerized ABS. The bulk polymerized ABS may comprise about 40 wt. % to about 95 wt. % elastomer-modified graft copolymer and about 5 wt. % to about 65 wt. % rigid copolymer, based on the total weight of the ABS. In another embodiment, the bulk polymerized ABS may comprise about 50 wt. % to about 85 wt. %, more specifically about 75 wt. % to about 85 wt. % elastomer-modified graft copolymer, together with about 15 wt. % to about 50 wt. %, more specifically about 15 wt. % to about 25 wt. % rigid copolymer, based on the total weight of the bulk polymerized ABS.

A variety of bulk polymerization methods for ABS-type resins are known. In multizone plug flow bulk processes, a series of polymerization vessels (or towers), consecutively connected to each other, providing multiple reaction zones. The elastomeric butadiene may be dissolved in one or more of the monomers used to form the rigid phase, and the elastomer solution is fed into the reaction system. During the reaction, which may be thermally or chemically initiated, the elastomer is grafted with the rigid copolymer (i.e., SAN). Bulk copolymer (referred to also as free copolymer, matrix copolymer, or non-grafted copolymer) is also formed within the continuous phase containing the dissolved rubber. As polymerization continues, domains of free copolymer are formed within the continuous phase of rubber/comonomers to provide a two-phase system. As polymerization proceeds, and more free copolymer is formed, the elastomer-modified copolymer starts to disperse itself as particles in the free copolymer and the free copolymer becomes a continuous phase (phase inversion). Some free copolymer is generally occluded within the elastomer-modified copolymer phase as well. Following the phase inversion, additional heating may be used to complete polymerization. Numerous modifications of this basis process have been described, for example in U.S. Pat. No. 3,511,895, which describes a continuous bulk polymerized ABS process that provides controllable molecular weight distribution and microgel particle size using a three-stage reactor system. In the first reactor, the elastomer/monomer solution is charged into the reaction mixture under high agitation to precipitate discrete rubber particle uniformly throughout the reactor mass before appreciable cross-linking can occur. Solids levels of the first, the second, and the third reactor are carefully controlled so that molecular weights fall into a desirable range. U.S. Pat. No. 3,981,944 discloses extraction of the elastomer particles using the styrenic monomer to dissolve/disperse the elastomer particles, prior to addition of the unsaturated monomer comprising a nitrile group and any other comonomers. U.S. Pat. No. 5,414,045 discloses reacting in a plug flow grafting reactor a liquid feed composition comprising a styrenic monomer composition, an unsaturated nitrile monomer composition, and an elastomeric butadiene polymer to a point prior to phase inversion, and reacting the first polymerization product (grafted elastomer) therefrom in a continuous-stirred tank reactor to yield a phase inverted second polymerization product that then can be further reacted in a finishing reactor, and then devolatilized to produce the desired final product. In various embodiments, the bulk polymerized ABS (BABS) may contain a nominal 15 wt. % butadiene and a nominal 15 wt. % acrylonitrile. The microstructure is phased inverted, with occluded SAN in a butadiene phase in a SAN matrix. The BABS was manufactured using a plug flow reactor in series with a stirred, boiling reactor as described, for example, in U.S. Pat. No. 3,981,944 and U.S. Pat. No. 5,414,045.

In one embodiment, a composition comprises about 40 wt. % to about 75 wt. % of a polycarbonate resin, about 10 wt. % to about 40 wt. % BABS, e.g., about 16 wt. % to about 39 wt. % BABS, and about 1 wt. % to about 50 wt. % of a polycarbonate-polysiloxane copolymer, based on their combined weights. In some embodiments, the composition comprises about 50 wt. % to about 75 wt. % of a polycarbonate resin, about 15 wt. % to about 40 wt. % BABS, and about 1 wt. % to about 20 wt. % of a polycarbonate-polysiloxane copolymer. Optionally, the composition may comprise 20 wt. % to 35 wt. % BABS. In one specific embodiment, a thermoplastic composition comprises about 57 wt. % polycarbonate, about 26.4 wt. % BABS and about 16.6 wt. % polycarbonate-polysiloxane copolymer based on their combined weights.

Optionally, at least one selected component of the composition, for example, one or more polymeric components and/or one or more additives are substantially free of compounds that adversely affect the desired properties of the thermoplastic compositions, in particular hydrolytic and/or thermal stability. Thus, additives that contain impurities or that would generate degradation catalysts in the presence of moisture (e.g., as a result of hydrolytic aging), for example hydrolytically unstable phosphites such as tris-nonylphenylphosphite, phenyldi-isodecylphosphite, bis(2,4-di-tertbutylphenol)pentaerythritoldiphosphite, and the like, would not be as desirable. In a preferred embodiment, each additive is substantially free of compounds that would cause the degradation of polycarbonates. As used herein “degradation of polycarbonates” means a measurable decrease in the molecular weight of the polycarbonates, and includes but is not limited to transesterification and/or hydrolytic degradation. Such degradation may occur over time, and may be accelerated by conditions of humidity and/or heat. Methods for the measurement of polycarbonate degradation are known, and include, for example, determination of change in spiral flow, melt viscosity, melt volume, molecular weight, impact resistance and the like.

Compounds that can cause the degradation of polycarbonate include but are not limited to impurities, by-products, and residual compounds used in the manufacture of the components of the impact modifier composition, for example certain residual acids, residual bases, residual emulsifiers, and/or residual metals that may catalyze the degradation of polycarbonate. One method of determining whether a component such as an impact modifier or other additive is substantially free of compounds that can cause or catalyze the degradation of polycarbonate is to measure the pH of a slurry or solution of the individual component(s). For example, 1 gram of powder impact modifier will be slurried with 10 ml of pH 7.0 distilled water, with one drop of reagent grade methyl alcohol added to reduce surface tension. The slurry will be agitated for 10 minutes and then the pH is measured. In one embodiment, a slurry of the component, or of the composition, having a pH of about 4 to about 8, optionally about 5 to about 7 or, in a specific embodiment, a pH of about 6 to about 7, is deemed to indicate that the component or composition is substantially free of compounds that can cause the degradation of polycarbonate. Optionally, the same test can be applied to a combination of the components or to the finished thermoplastic composition, but determining the pH of each component individually may more accurately reflect the presence of compounds that degrade polycarbonates. In some cases it may be effective to adjust the pH of a slurry or solution of a component prior to admixture with the remaining components. Alternatively, the component can be extracted with water and the pH of the aqueous layer determined. In some cases it may be effective to adjust the pH of a slurry or solution of a component prior to admixture with the remaining components.

As indicated above, various additives known in the art may be added to these compositions, and mixtures of additives may be used. Such additives include fillers, reinforcing agents, pigments, antioxidants, heat and color stabilizers, light stabilizers, etc. Additives may be added at a suitable time during the mixing of the components for forming the composition.

Suitable fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene (Teflon) and the like; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

The fillers and reinforcing agents may be coated with a layer of metallic material to facilitate conductivity, or surface treated with silanes to improve adhesion and dispersion with the polymeric matrix resin. In addition, the reinforcing fillers may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids. Fillers are generally used in amounts of about 0 to about 40 parts by weight, based on 100 parts by weight of the polycarbonate component and the impact modifier composition.

Suitable antioxidant additives include, for example, alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; or the like; or combinations comprising at least one of the foregoing antioxidants. Antioxidants are generally used in amounts of about 0.01 parts by weight to about 1 parts by weight, specifically about 0.1 parts by weight to about 0.5 parts by weight, based on 100 parts by weight of polycarbonate component and any impact modifier.

Suitable heat and color stabilizer additives include, for example, organophosphites such as tris(2,4-di-tertbutyl phenyl) phosphite. Heat and color stabilizers are generally used in amounts of about 0.01 parts by weight to about 5 parts by weight, specifically about 0.05 parts by weight to about 0.3 parts by weight, based on 100 parts by weight of polycarbonate component and any impact modifier.

Suitable secondary heat stabilizer additives include, for example thioethers and thioesters such as pentaerythritol tetrakis (3-(dodecylthio)propionate), pentaerythritol tetrakis[3-(3,5-di-tert-butyl-4-hydroxyphenyl)propionate], dilauryl thiodipropionate, distearyl thiodipropionate, dimyristyl thiodipropionate, ditridecyl thiodipropionate, penterythritol octylthiopropionate, dioctadecyl disulphide, or the like, or combinations comprising at least one of the foregoing heat stabilizers. Secondary stabilizers are generally used in amount of about 0.01 parts by weight to about 5 parts by weight, specifically about 0.03 parts by weight to about 0.3 parts by weight, based upon 100 parts by weight of polycarbonate component and any impact modifier.

Light stabilizers, including ultraviolet light (UV) absorbing additives, may also be used. Suitable stabilizing additives of this type include, for example, benzotriazoles and hydroxybenzotriazoles such as 2-(2-hydroxy-5-methylphenyl)benzotriazole, 2-(2-hydroxy-5-tert-octylphenyl)-benzotriazole, 2-(2H-benzotriazol-2-yl)-4-(1,1,3,3-tetramethylbutyl)-phenol (CYASORB 5411 from Cytec), and TINUVIN 234 from Ciba Specialty Chemicals; hydroxybenzotriazines; hydroxyphenyl-triazine or -pyrimidine UV absorbers such as TINUVIN 1577 (Ciba), and 2-[4,6-bis(2,4-dimethylphenyl)-1,3,5-triazin-2-yl]-5-(octyloxy)-phenol (CYASORB 1164 from Cytec); non-basic hindered amine light stabilizers (hereinafter “HALS”), including substituted piperidine moieties and oligomers thereof, for example 4-piperidinol derivatives such as TINUVIN 622 (Ciba), GR-3034, TINUVIN 123, and TINUVIN 440; benzoxazinones, such as 2,2′-(1,4-phenylene)bis(4H-3,1-benzoxazin-4-one) (CYASORB UV-3638); hydroxybenzophenones such as 2-hydroxy-4-n-octyloxybenzophenone (CYASORB 531); oxanilides; cyanoacrylates such as 1,3-bis[(2-cyano-3,3-diphenylacryloyl)oxy]-2,2-bis[[(2-cyano-3,3-diphenylacryloyl)oxy]methyl]propane (UVINUL 3030) and 1,3-bis[(2-cyano-3,3-diphenylacryloyl)oxy]-2,2-bis[[(2-cyano-3,3-diphenylacryloyl)oxy]methyl]propane; and nano-size inorganic materials such as titanium oxide, cerium oxide, and zinc oxide, all with particle size less than about 100 nanometers; and the like, and combinations comprising at least one of the foregoing stabilizers. Light stabilizers may be used in amounts of about 0.01 parts by weight to about 10 parts by weight, specifically about 0.1 parts by weight to about 1 parts by weight, based on 100 parts by weight of polycarbonate and impact modifier. UV absorbers are generally used in amounts of about 0.1 parts by weight to about 5 parts by weight, based on 100 parts by weight of the polycarbonate component and the impact modifier composition.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like; and poly alpha olefins such as Ethylflo 164, 166, 168, and 170. Such materials are generally used in amounts of about 0.1 parts by weight to about 20 parts by weight, specifically about 1 part by weight to about 10 parts by weight, based on 100 parts by weight of the polycarbonate component and the impact modifier composition.

Colorants such as pigment and/or dye additives may also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments. Pigments may be coated to prevent reactions with the matrix or may be chemically passivated to neutralize catalytic degradation site that might promote hydrolytic or thermal degradation. For example, pigments may be passivated by neutralizing acidic or basic impurities in the pigment composition. Pigments are generally used in amounts of about 0.01 parts by weight to about 10 parts by weight, based on 100 parts by weight of polycarbonate resin and any impact modifier.

Suitable dyes are generally organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted Poly (C₂₋₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 7-amino-4-trifluoromethylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)-1,3,4-oxadiazole; 2-(4-biphenylyl)-5-phenyl-1,3,4-oxadiazole; 2-(4-biphenyl)-6-phenylbenzoxazole-1,3; 2,5-bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 1,1′-diethyl-4,4′-carbocyanine iodide; 3,3′-diethyl-4,4′,5,5′-dibenzothiatricarbocyanine iodide; 1,1′-diethyl-4,4′-dicarbocyanine iodide; 1,1′-diethyl-2,2′-dicarbocyanine iodide; 3,3′-diethyl-9,11-neopentylenethiatricarbocyanine iodide; 1,3′-diethyl-4,2′-quinolyloxacarbocyanine iodide; 1,3′-diethyl-4,2′-quinolylthiacarbocyanine iodide; 3-diethylamino-7-diethyliminophenoxazonium perchlorate; 7-diethylamino-4-methylcoumarin; 7-diethylamino-4-trifluoromethylcoumarin; 7-diethylaminocoumarin; 3,3′-diethyloxadicarbocyanine iodide; 3,3′-diethylthiacarbocyanine iodide; 3,3′-diethylthiadicarbocyanine iodide; 3,3′-diethylthiatricarbocyanine iodide; 4,6-dimethyl-7-ethylaminocoumarin; 2,2′-dimethyl-p-quaterphenyl; 2,2-dimethyl-p-terphenyl; 7-dimethylamino-1-methyl-4-methoxy-8-azaquinolone-2; 7-dimethylamino-4-methylquinolone-2; 7-dimethylamino-4-trifluoromethylcoumarin; 2-(4-(4-dimethylaminophenyl)-1,3-butadienyl)-3-ethylbenzothiazolium perchlorate; 2-(6-(p-dimethylaminophenyl)-2,4-neopentylene-1,3,5-hexatrienyl)-3-methylbenzothiazolium perchlorate; 2-(4-(p-dimethylaminophenyl)-1,3-butadienyl)-1,3,3-trimethyl-3H-indolium perchlorate; 3,3′-dimethyloxatricarbocyanine iodide; 2,5-diphenylfuran; 2,5-diphenyloxazole; 4,4′-diphenylstilbene; 1-ethyl-4-(4-(p-dimethylaminophenyl)-1,3-butadienyl)-pyridinium perchlorate; 1-ethyl-2-(4-(p-dimethylaminophenyl)-1,3-butadienyl)-pyridinium perchlorate; 1-ethyl-4-(4-(p-dimethylaminophenyl)-1,3-butadienyl)-quinolium perchlorate; 3-ethylamino-7-ethylimino-2,8-dimethylphenoxazin-5-ium perchlorate; 9-ethylamino-5-ethylamino-10-methyl-5H-benzo(a) phenoxazonium perchlorate; 7-ethylamino-6-methyl-4-trifluoromethylcoumarin; 7-ethylamino-4-trifluoromethylcoumarin; 1,1′,3,3,3′,3′-hexamethyl-4,4′,5,5′-dibenzo-2,2′-indotricarboccyanine iodide; 1,1′,3,3,3′,3′-hexamethylindodicarbocyanine iodide; 1,1′,3,3,3′,3′-hexamethylindotricarbocyanine iodide; 2-methyl-5-t-butyl-p-quaterphenyl; N-methyl-4-trifluoromethylpiperidino-<3,2-g>coumarin; 3-(2′-N-methylbenzimidazolyl)-7-N,N-diethylaminocoumarin; 2-(1-naphthyl)-5-phenyloxazole; 2,2′-p-phenylen-bis(5-phenyloxazole); 3,5,3″″,5″″-tetra-t-butyl-p-sexiphenyl; 3,5,3″″,5″″-tetra-t-butyl-p-quinquephenyl; 2,3,5,6-1H,4H-tetrahydro-9-acetylquinolizino-<9,9a,1-gh>coumarin; 2,3,5,6-1H,4H-tetrahydro-9-carboethoxyquinolizino-<9,9a,1-gh> coumarin; 2,3,5,6-1H,4H-tetrahydro-8-methylquinolizino-<9,9a, 1-gh> coumarin; 2,3,5,6-1H,4H-tetrahydro-9-(3-pyridyl)-quinolizino-<9,9a,1-gh> coumarin; 2,3,5,6-1H,4H-tetrahydro-8-trifluoromethylquinolizino-<9,9a,1-gh> coumarin; 2,3,5,6-1H,4H-tetrahydroquinolizino-<9,9a,1-gh>coumarin; 3,3′,2″,3′″-tetramethyl-p-quaterphenyl; 2,5,2″″,5′″-tetramethyl-p-quinquephenyl; P-terphenyl; P-quaterphenyl; nile red; rhodamine 700; oxazine 750; rhodamine 800; IR 125; IR 144; IR 140; IR 132; IR 26; IR5; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations comprising at least one of the foregoing dyes. Dyes are generally used in amounts of about 0.1 parts per million to about 10 parts by weight, based on 100 parts by weight of polycarbonate resin and any impact modifier.

Monomeric, oligomeric, or polymeric antistatic additives that may be sprayed onto the article or processed into the thermoplastic composition may be advantageously used. Examples of monomeric antistatic agents include long chain esters such as glycerol monostearate, glycerol distearate, glycerol tristearate, and the like, sorbitan esters, and ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate and the like, fluorinated alkylsulfonate salts, betaines, and the like. Combinations of the foregoing antistatic agents may be used. Exemplary polymeric antistatic agents include certain, polyetheresters, each containing polyalkylene glycol moieties such as polyethylene glycol, polypropylene glycol, polytetramethylene glycol, and the like. Such polymeric antistatic agents are commercially available, and include, for example PELESTAT 6321 (Sanyo), PEBAX MH1657 (Atofina), and IRGASTAT P18 and P22 (Ciba-Geigy). Other polymeric materials that may be used as antistatic agents are inherently conducting polymers such as polythiophene (commercially available from Bayer), which retains some of its intrinsic conductivity after melt processing at elevated temperatures. In one embodiment, carbon fibers, carbon nanofibers, carbon nanotubes, carbon black or any combination of the foregoing may be used in a polymeric resin containing chemical antistatic agents to render the composition electrostatically dissipative. Antistatic agents are generally used in amounts of about 0.1 parts by weight to about 10 parts by weight, specifically about based on 100 parts by weight of the polycarbonate component and the impact modifier composition.

Where a foam is desired, suitable blowing agents include, for example, low boiling halohydrocarbons and those that generate carbon dioxide; blowing agents that are solid at room temperature and when heated to temperatures higher than their decomposition temperature, generate gases such as nitrogen, carbon dioxide, or ammonia gas, such as azodicarbonamide, metal salts of azodicarbonamide, 4,4′-oxybis(benzenesulfonylhydrazide), sodium bicarbonate, ammonium carbonate, or the like, or combinations comprising at least one of the foregoing blowing agents. Blowing agents are generally used in amounts of about 0.5 parts by weight to about 20 parts by weight, based on 100 parts by weight of polycarbonate component and the impact modifier composition.

Suitable flame retardants that may be added to the composition include those that are hydrolytically stable. A hydrolytically stable flame retardant does not substantially degrade under conditions of manufacture and/or use to generate compounds that can catalyze or otherwise contribute to the degradation of the polycarbonate composition. Such flame retardants may be organic compounds that include phosphorus, bromine, and/or chlorine. The polycarbonate-polysiloxane copolymers described above may also be used. Non-brominated and non-chlorinated phosphorus-containing flame retardants may be preferred in certain applications for regulatory reasons, for example certain organic phosphates and/or organic compounds containing phosphorus-nitrogen bonds.

Anti-drip agents may also be used, for example a fibril forming or non-fibril forming fluoropolymer such as polytetrafluoroethylene (PTFE). The anti-drip agent may be encapsulated by a rigid copolymer as described above, for example SAN. PTFE encapsulated in SAN is known as TSAN. Encapsulated fluoropolymers may be made by polymerizing the encapsulating polymer in the presence of the fluoropolymer, for example an aqueous dispersion. TSAN may provide significant advantages over PTFE, in that TSAN may be more readily dispersed in the composition. A suitable TSAN may comprise, for example, about 50 wt. % PTFE and about 50 wt. % SAN, based on the total weight of the encapsulated fluoropolymer. The SAN may comprise, for example, about 75 wt. % styrene and about 25 wt. % acrylonitrile based on the total weight of the copolymer. Alternatively, the fluoropolymer may be pre-blended in some manner with a second polymer, such as for, example, an aromatic polycarbonate resin or SAN to form an agglomerated material for use as an anti-drip agent. Either method may be used to produce an encapsulated fluoropolymer. Antidrip agents are generally used in amounts of about 0.1 parts by weight to about 10 parts by weight, based on 100 parts by weight of polycarbonate component and the impact modifier composition.

The thermoplastic compositions may be manufactured by methods generally available in the art, for example, in one embodiment, in one manner of proceeding, powdered polycarbonate, polycarbonate-polysiloxane copolymer, impact modifier composition comprising bulk polymerized ABS, and any other optional components are first blended, optionally with chopped glass strands or other fillers in a Henschel high speed mixer. Other low shear processes including but not limited to hand mixing may also accomplish this blending. The blend is then fed into the throat of a twin-screw extruder via a hopper. Alternatively, one or more of the components may be incorporated into the composition by feeding directly into the extruder at the throat and/or downstream through a sidestuffer. Such additives may also be compounded into a masterbatch with a desired polymeric resin and fed into the extruder. The additives may be added to either the polycarbonate base materials or the ABS base material to make a concentrate, before this is added to the final product. The extruder is generally operated at a temperature higher than that necessary to cause the composition to flow, typically 500° F. (260° C.) to 650° F. (343° C.). The extrudate is immediately quenched in a water batch and pelletized. The pellets, prepared by cutting the extrudate, may be about one-fourth inch long or less as desired. Such pellets may be used for subsequent molding, shaping, or forming into a variety of useful articles by processes known in the art for the manufacture of articles from thermoplastic compositions.

The thermoplastic compositions described herein can be shaped, formed, or molded into a variety of articles. The thermoplastic compositions may be molded into useful shaped articles by a variety of means such as injection molding, extrusion, rotational molding, blow molding and thermoforming to form articles such as, for example, computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like.

The compositions find particular utility in automotive applications, for example as instrument panels, overhead consoles, interior trim, center consoles, and the like.

Compositions as described herein have advantageous physical properties such as low temperature impact resistance, and also have good thermal stability and good hydrolytic aging stability. Stability for thermal aging (elevated temperature, low relative humidity) and hydrolytic aging (elevated temperature and high relative humidity) can be measured by comparing a physical property such as low temperature impact resistance or molecular weight before and after aging under aging conditions. Changes in the measured physical properties indicate the extent of degradation of the composition as a result of exposure to the simulated aging conditions. Degraded materials would generally have reduced impact resistance and reduced molecular weight, indicating changes to be expected in other important physical properties as well. Typically, molecular weights are determined before and after storage under conditions of high humidity, then a percentage difference is calculated.

As demonstrated below, the compositions described herein possess good thermal aging stability and hydrolytic aging stability, as reflected in percent change in impact resistance and/or molecular weight. In particular, the data shows that by combining polycarbonate with bulk polymerized ABS rather than emulsion-prepared ABS and SAN, an unexpected improvement in physical properties and thermal and hydrolytic aging is attained.

The thermoplastic polycarbonate compositions may have a Vicat B/50 of about 120° C. to about 140° C., more specifically about 126° C. to about 132° C., determined using a 4 mm thick bar per ISO 306.

The thermoplastic polycarbonate compositions may further have a Instrumented Impact Energy (dart impact) at maximum load of at least about 20 ft-lbs, preferably at least about 30 ft-lbs, determined using a 4-inch (10 cm) diameter disk at −30° C., ½-inch (12.7 mm) diameter dart, and an impact velocity of 6.6 meters per second (m/s) per ASTM D3763.

Carbon emissions from the samples may be determined in accordance with PV 3341. Carbon emissions may be less than about 30 micrograms of carbon per gram of composition, optionally less than about 25 micrograms of carbon per gram of composition, for example, optionally less than about 20 micrograms of carbon per gram of composition.

The invention is further illustrated by the following non-limiting Examples.

In each of the examples, samples were prepared by melt extrusion on a Werner & Pfleider 25 mm twin screw extruder using steam stripped designed screws, a nominal melt temperature of 260° C., 25 inches (635 mm) of mercury vacuum, and 450 rpm. The extrudate was pelletized and dried at about 100° C. for about 2 hours. To make test specimens, the dried pellets were injection molded on an 110-ton injection molding machine at a nominal melt temperature of 260° C., wherein the barrel temperature of the injection molding machine varied from about 260° C. to about 275° C.

Tests were conducted in accordance with the following standards: Carbon emissions, measured from small species cut from tensile bar, was determined per PV 3341; Izod Impact, 4 mm thick bar, molded Izod notched impact (INI) bar, was determined per ISO 180/1A; Melt Viscosity (MV), was determined per DIN 54811; Vicat B/50, 4 mm thick bar, cut from molded INI bar, was determined per ISO 306, ASTM D 1525; Heat Deflection Test (HDT), 1.8 MPa, flat, 4 mm thick bar, molded Tensile bar, was determined per ISO 75Ae; and Polycarbonate Molecular Weight (PC Mw), was measured with reference to polystyrene molecular weight standards, unless otherwise stated. The foregoing tests are summarized as follows. Precise details of each test will be known to one of skill in the art.

In a carbon emissions test pursuant to PV 3341, one gram of the material to be tested for emissions is placed in a sealed vial, which is heated to 120° C. for five hours. The heated headspace in the vial is injected into a gas chromatograph. A value relative to acetone is determined as micro gram carbon per gram of sample. To reduce carbon emissions from a material, it is known in the art to strip volatile organic species from the material with steam, an inert gas, or other stripping medium, by exposing the material to the stripping medium so that volatile species combine with the stripping medium, which is then removed from the material, as is known in the art. The resulting stripped material generates fewer emissions than a non-stripped material.

Izod Impact Strength ASTM D 256 (ISO 180) (‘INI’) is used to compare the impact resistances of plastic materials. The ISO designation reflects type of specimen and type of notch: ISO 180/1A means specimen type 1 and notch type A. ISO 180/1U means the same type 1 specimen, but clamped in a reversed way, (indicating unnotched). The ISO results are defined as the impact energy in joules used to break the test specimen, divided by the specimen area at the notch. Results are reported in kJ/m².

Melt viscosity (MV) is a measure of a polymer at a given temperature at which the molecular chains can move relative to each other. Melt viscosity is dependent on the molecular weight, in that the higher the molecular weight, the greater the entanglements and the greater the melt viscosity, and can therefore be used to determine the extent of degradation of the thermoplastic as a result of exposure to heat and/or humidity. Degraded materials would generally show increased viscosity, and could exhibit reduced physical properties. Melt viscosity is determined against different shear rates such as 100; 500; 1,000; 1,500; 5,000; and 10,000 s⁻¹, and may be conveniently determined by DIN 54811. Typically, melt viscosities are determined before and after storage under conditions of high humidity, then a percentage difference is calculated. Measured at 260° C., 1500 s⁻¹, the MV for the thermoplastic compositions described herein may be 210 Pascal-seconds (Pa·s) or less, sometimes about 190 to about 210 Pa·s, optionally less than 190 Pa·s.

Vicat Softening Temperature (ISO 306) This test gives a measure of the temperature at which a plastic starts to soften rapidly. A round, flat-ended needle of 1 mm² cross section penetrates the surface of a plastic test specimen under a predefined load, and the temperature is raised at a uniform rate. The Vicat softening temperature, or VST, is the temperature at which the penetration reaches 1 mm. ISO 306 describes two methods: Method A—load of 10 Newtons (N), and Method B—load of 50 N, with two possible rates of temperature rise: 50° C./hour (° C./h) or 120° C./h. This results in ISO values quoted as A50, A120, B50 or B120. The test assembly is immersed in a heating bath with a starting temperature of 23° C. (73° F.). After 5 minutes (min) the load is applied: 10 N or 50 N. The temperature of the bath at which the indenting tip has penetrated by 1±0.01 mm is reported as the VST of the material at the chosen load and temperature rise.

Heat Deflection Temperature (HDT) is a relative measure of a material's ability to perform for a short time at elevated temperatures while supporting a load. The test measures the effect of temperature on stiffness: a standard test specimen is given a defined surface stress and the temperature is raised at a uniform rate. Although not mentioned in either test standard, two acronyms are commonly used: HDT/A for a load of 1.80 MPa, and HDT/B for a load of 0.45 MPa.

Molecular weight is measured by GPC (gel permeation chromatography) in methylene chloride solvent. Polystyrene calibration standards are used to determine relative molecular weights.

### EXAMPLE 1

Five polymeric blend materials were compared to determine the possible advantage of using bulk polymerized ABS in place of ABS (i.e., emulsion-based ABS) and SAN as impact modifiers in combination with a polycarbonate resin plus stabilizers and mold release agents as are known in the art. The polymeric components of the blends are characterized in Table 1A. The compositions of the five samples is indicated in Table 1B. In addition to the components listed in Table 1B, each sample comprised about 0.45 to 0.8 wt. % additives, including a phosphite stabilizer, a mold release agent and an antioxidant. All five samples (the compositions of which are indicated in Table 1B) contained polycarbonate resin comprising PC-1 and PC-2; four of the five (samples A, B, C and E) also comprised emulsion-type ABS and SAN, while the fifth sample (sample D) comprised bulk polymerized ABS instead.

Prior to aging, the samples were tested with respect to carbon emissions, notched Izod impact strength (INI), melt viscosity (MV) and Vicat softening temperature.

The test samples were subjected to thermal aging (exposure to 110° C. for 1,000 hours at low humidity (about 1% relative humidity (RH) to 2% RH) and hydrolytic aging (exposure to 90° C. for 1,000 hours at 95% RH). After aging, the room temperature and −30° C. impact resistance were tested again, and the relative difference from pre-aging was noted. The molecular weight of polycarbonate extracted from the sample compositions (PC Mw) was also tested before and after aging, and the proportional change was noted as well. The results are set forth in Table 1B.

TABLE 1A

| Component | Type | Source |
|---|---|---|
| PC-1 | BPA polycarbonate resin made by a melt or | GE Advanced |
| | interfacial process with an MVR at 300° C./1.2 kg, of | Materials |
| | 23.5-28.5 g/10 min (per ASTM D1238). | |
| PC-2 | BPA polycarbonate resin made by a melt or | GE Advanced |
| | interfacial process with an MVR at 300° C./1.2 kg, of | Materials |
| | 5.1-6.9 g/10 min. | |
| PC EXL | Polycarbonate-polysiloxane copolymer comprising | GE Advanced |
| | units derived from BPA and units derived from | Materials |
| | formula (10), wherein n is 0, R² is propylene, R is | |
| | methyl, D has an average value of about 50, the | |
| | copolymer having an absolute weight average | |
| | molecular weight of about 30000 g/mol, and a | |
| | dimethylsiloxane content of about 20 wt. % | |
| Emulsion ABS | High rubber graft emulsion polymerized ABS | GE Advanced |
| | comprising 15 wt. % to 35 wt. % acrylonitrile and 85 wt. %-65 wt. % | Materials |
| | styrene grafted on to a core of 85-100 wt. % | |
| | butadiene and with a 15 wt. %-0 wt. % | |
| | styrene. The core represents about 25%-75% of | |
| | the total emulsion ABS. The materials are | |
| | crosslinked to a density of 43%-55% as measured | |
| | by sol-gel fraction. | |
| SAN | Styrene acrylonitrile copolymer comprising 15-35 wt. % | GE Advanced |
| | acrylonitrile with an MVR at 220° C./1.2 kg of | Materials |
| | 13-24 cm³/10 min | |
| Bulk | Bulk polymerized ABS comprising 12 wt. % to 24 wt. % | GE Advanced |
| polymerized | butadiene and the balance styrene/acrylonitrile | Materials |
| ABS | copolymer of 12 wt. % to 35 wt. % acrylonitrile. A | |
| | substantial portion of the SAN is occluded within | |
| | the butadiene polymer phase. | |

TABLE 1B

| | Sample | | | | |
|---|---|---|---|---|---|
| | A | B | C | D | E |
| PC-1 | 46.90 | 40.10 | 46.90 | 15.6 | 48.3 |
| PC-2 | 22.10 | 25.90 | 22.10 | 36.4 | 20.7 |
| SAN | 12.80 | 21.00 | 12.80 | — | 12.8 |
| Emulsion ABS | 18.20 | 13.00 | 18.20 | — | 18.2 |
| Bulk polymerized | — | — | — | 48 | — |
| ABS instead of | | | | | |
| ABS + SAN | | | | | |
| C-emissions w/o | 21.3 | 22.8 | 23.8 | 20.9 | 23.7 |
| steamstripping μg | | | | | |
| C/g | | | | | |
| INI RT kJ/m² | 49.7 | 46.2 | 51.0 | 62.8 | 53.7 |
| INI −30° C. kJ/m² | 41.0 | 22.6 | 46.9 | 18.7 | 43.6 |
| INI −40° C. kJ/m² | 26.3 | 21.1 | 30.5 | 17.4 | 23.5 |
| INI −50° C. kJ/m² | 20.6 | 16.9 | 21.0 | 15.6 | 19.4 |
| INI −60° C. kJ/m² | 17.9 | 14.3 | 19.4 | 12.4 | 15.9 |
| MV, 260° C. | | | | | |
| 1,000/s | 232.7 | 239.0 | 241.0 | 191.7 | 239.4 |
| 1,500/s | 187.0 | 186.8 | 193.4 | 149.8 | 190.2 |
| 5,000/s | 89.3 | 84.4 | 92.5 | 66.7 | 91.3 |
| 10,000/s | 57.4 | 53.9 | 59.2 | 40.7 | 57.8 |
| Vicat B/50 | 125.2 | 123.4 | 124.7 | 114.1 | 125.6 |
| HDT 1.m Mpa | 104.3 | 103.8 | 105.0 | 97.1 | 105.4 |
| Flat | | | | | |

Retention of value after Heat aging (%)

| | | | | | |
|---|---|---|---|---|---|
| INI RT kJ/m² | 67 | 45 | 71 | 51 | 72 |
| INI −30° C. kJ/m² | 45 | 34 | 41 | 40 | 38 |
| PC Mw | 88 | 92 | 92 | 101 | 93 |

Retention of value after Hydrolytic aging (%)

| | | | | | |
|---|---|---|---|---|---|
| INI RT kJ/m² | 5 | 5 | 5 | 61 | 5 |
| INI −30° C. kJ/m² | 6 | 10 | 5 | 76 | 7 |
| PC Mw | 28 | 39 | 43 | 92 | 31 |

The data of Table 1 shows that bulk polymerized ABS combined with polycarbonate (sample D) provides unexpectedly superior INI RT strength and retention of in physical properties after hydrolytic aging relative to compositions containing emulsion-based ABS. Sample D retained 61% of its room temperature impact resistance, whereas the other samples retained only 5%. In addition, sample D retained 76% of its INI −30° C. strength, whereas the other samples retained only 5% to 10%. Finally, sample D retained 92% of its molecular weight, whereas the other samples all lost more than 50% of their molecular weight. This data thus demonstrates the significant but unexpected synergistic effect on resistance to hydrolytic aging achieved by combining BABS with polycarbonate.

### EXAMPLE 2

A number of polymeric compositions comprising blends of polycarbonate and BABS was prepared from the components of Table 1A plus stabilizers and mold release agents as are known in the art. Some of these compositions contained polycarbonate-polysiloxane copolymer to constitute a composition as described herein, with siloxane contents of 1 wt. % to 4 wt % by weight of the composition. The proportions of the components in each of the compositions are indicated in Table 2. Prior to testing, some samples were steam stripped (a process commonly used to reduce emissions of volatile compounds from finished products); others were not. Prior to aging, the compositions were tested for carbon emissions, INI RT and INI at several low temperatures, melt viscosity, Vicat softening temperature, and heat deflection temperature (HDT). Test samples were subjected to thermal aging (exposure to 110° C. for 1,000 hours at ambient humidity, i.e., about 1% relative humidity (RH) to about 2% RH) and hydrolytic aging (exposure to 90° C. for 1,000 hours at 95% RH). After aging, the INI RT and INI −30° C. strengths were tested again, and the relative difference from pre-aging was noted. The molecular weight of polycarbonate extracted from each sample was also tested before and after aging, and the proportional change was noted as well. The results are set forth in Table 2.

TABLE 2

| | | Sample | | | | | | | | | | | |
|---|---|---|---|---|---|---|---|---|---|---|---|---|---|
| | | F | G | H | I | J | K | L | M | N | O | P | Q |
| Steam Stripping | | yes | no | no | no | yes | no | no | yes | no | yes | yes | yes |
| PC EXL | | 0.0 | 0.0 | 10.1 | 10.1 | 10.1 | 20.1 | 20.1 | 20.1 | 0.0 | 5.0 | 20.1 | 0.0 |
| BABS | | 39.0 | 31.0 | 27.9 | 27.9 | 35.1 | 24.8 | 24.8 | 31.2 | 35.0 | 31.3 | 29.6 | 39.0 |
| PC-1 | | 20.9 | 56.7 | 51.0 | 51.0 | 18.8 | 45.3 | 45.3 | 16.7 | 40.4 | 31.6 | 36.7 | 50.1 |
| PC-2 | | 40.1 | 12.3 | 11.1 | 11.1 | 36.1 | 9.9 | 9.9 | 32.1 | 24.6 | 32.1 | 13.6 | 10.9 |
| C-Emissions | | | | | | | | | | | | | |
| W/o steam stripping | μg C/g | — | 23.1 | 21.0 | 19.4 | — | 22.1 | 20.6 | — | 24.8 | — | — | — |
| W/ steam stripping | μg C/g | 19.5 | — | — | — | 17.6 | — | — | 18.0 | — | 15.4 | 16.8 | 19.7 |
| INI RT | kJ/m² | 58.8 | 50.5 | 56.4 | 56.1 | 67.2 | 57.5 | 56.7 | 62.6 | 54.7 | 58.6 | 56.9 | 48.1 |
| INI −30° C. | kJ/m² | 46.6 | 33.2 | 44.2 | 44.3 | 52.2 | 45.2 | 46.5 | 53.0 | 41.4 | 44.5 | 47.8 | 27.0 |
| INI −40° C. | kJ/m² | 34.1 | 25.3 | 42.7 | 41.5 | 51.8 | 44.9 | 44.1 | 52.8 | 27.1 | 36.0 | 47.5 | 22.8 |
| INI −50° C. | kJ/m² | 23.4 | 21.4 | 25.9 | 25.9 | 34.2 | 41.3 | 41.2 | 51.0 | 22.7 | 26.2 | 44.5 | 20.7 |
| INI −60° C. | kJ/m² | 21.9 | 19.6 | 24.3 | 23.4 | 25.3 | 31.4 | 30.6 | 39.1 | 19.8 | 23.5 | 30.9 | 18.9 |
| MV @ 260° C. at | | | | | | | | | | | | | |
| indicated shear rate | | | | | | | | | | | | | |
| 1,000/s | Pa · s | 174.9 | 199.6 | 220.3 | 223.1 | 217.9 | 236.3 | 237.0 | 229.1 | 206.7 | 221.1 | 211.5 | 185.7 |
| 1,500/s | Pa · s | 149.5 | 161.5 | 175.1 | 176.1 | 170.3 | 186.8 | 185.5 | 180.1 | 163.4 | 176.1 | 166.0 | 145.8 |
| 5,000/s | Pa · s | 71.0 | 76.2 | 81.2 | 82.5 | 77.9 | 84.2 | 84.4 | 80.8 | 74.5 | 82.3 | 76.8 | 67.0 |
| 10,000/s | Pa · s | 43.6 | 48.2 | 50.6 | 51.7 | 47.6 | 52.3 | 53.0 | 49.2 | 46.5 | 51.0 | 47.6 | 41.9 |
| Vicat B/50 | C. | 119.3 | 126.3 | 125.0 | 125.9 | 119.9 | 126.0 | 125.5 | 120.7 | 123.4 | 124.6 | 122.2 | 118.5 |
| HDT 1.8 Mpa Flat | C. | 97.5 | 102.0 | 102.8 | 102.6 | 99.0 | 102.7 | 103.5 | 99.6 | 99.8 | 101.7 | 99.6 | 98.0 |
| Retention of value | | | | | | | | | | | | | |
| after Heat Aging | | | | | | | | | | | | | |
| 1,000 hrs at 110° C., | | | | | | | | | | | | | |
| low humidity | | | | | | | | | | | | | |
| INI RT | % | 78 | 80 | 84 | 86 | 85 | 84 | 86 | 89 | 83 | 87 | 89 | 80 |
| INI −30° C. | % | 73 | 65 | 81 | 82 | 84 | 85 | 83 | 84 | 64 | 88 | 85 | 74 |
| PC Mw | % | 100 | 99 | 97 | 99 | 99 | 98 | 98 | 98 | 98 | 97 | 99 | 96 |
| Retention of value | | | | | | | | | | | | | |
| after Hydrolytic | | | | | | | | | | | | | |
| Aging 1,000 hrs at | | | | | | | | | | | | | |
| 90° C., 95% RH | | | | | | | | | | | | | |
| INI RT | % | 63 | 59 | 51 | 64 | 64 | 68 | 67 | 69 | 60 | 65 | 65 | 39 |
| INI −30° C. | % | 38 | 48 | 40 | 41 | 37 | 54 | 51 | 56 | 43 | | 46 | 27 |
| PC Mw | % | 83 | 85 | 85 | 88 | 80 | 86 | 88 | 80 | 82 | 84 | 84 | 82 |

The data of Table 2 shows that, prior to aging, compositions comprising a combination of BABS, polycarbonate and polycarbonate-polysiloxane copolymer as described herein (samples H, I, J, K, L, M, O and P) yields surprisingly superior INI low temperature strengths relative to comparative compositions having BABS and polycarbonate but lacking polycarbonate-polysiloxane copolymer (compositions F, G, N, and Q): at temperatures of −40° C., −50° C., and −60° C., all of the siloxane copolymer-containing compositions had superior INI relative to the comparative compositions. Specifically, some or all of samples H, I, J, K, L, M, O and P had, prior to aging, an INI −40° C. of at least about 36 kJ/m 2, e.g., in the range of about 36 kJ/m² to about 53 kJ/m²; other embodiments may have an INI −40° C. of about 40 kJ/m² to about 80 kJ/m². This shows that a siloxane content of at least about 1%, as provided in sample 0, yields good low temperature impact strength in a composition comprising polycarbonate, BABS and polycarbonate-polysiloxane copolymer. At −50° C., some or all of these samples can be characterized as having an INI −50° C. of at least 26 kJ/m², e.g., about 26 kJ/m² to about 51 kJ/m²; other embodiments may have an INI −50° C. of about 26 kJ/m² to about 70 kJ/m². Furthermore, some or all of samples H, I, J, K, L, M, O and P can be characterized as having an INI −60° C. strength of at least about 23 kJ/m², e.g., in the range of about 23 kJ/m² to about 40 kJ/m²; other embodiments may have an INI −60° C. of about 23 kJ/m² to about 60 kJ/m². The data of Table 2 also shows that compositions as described herein have good flow characteristics for extrusion and molding, as is evident from the tabulated melt viscosities. Moreover, the data shows that compositions as described herein have an HDT of greater than 100° C.

After thermal aging, samples H, I, J, K, L, M, O and P retained more of their INI RT and INI −30° C. than the comparative samples. In particular, the compositions described herein can be characterized as retaining more than 83% of their INI RT after thermal aging or, optionally, as maintaining 84% to about 89% of the INI RT, whereas samples F, G, O and Q all retained 83% of their INI RT or less. At −30° C., at least some samples can be characterized as maintaining more than 75% of their INI −30° C. strength or, optionally, at least about 80% of their INI −30° C., e.g., about 80 to about 90%, whereas samples F, G, O and Q all retained 74% of their INI −30° C. or less. No significant loss in molecular weight of the polycarbonate component of the compositions was noted.

After hydrolytic aging, samples H, I, J, K, L, M, O and P retained more of their impact resistance at room temperature (average INI RT retention of about 64%) and at −30° C. (average INI −30° C. retention of 46.4%) than the comparative samples (average INI RT retention of about 55.2%; average INI −30° C. retention of about 39%), showing that combining polycarbonate-polysiloxane copolymer with polycarbonate and BABS as described herein yields unexpectedly advantageous results in addition to the advantage of combining BABS with polycarbonate as demonstrated in Example 1. In particular, some samples can be characterized as retaining more than 60% of their INI RT after thermal aging or, optionally, as maintaining 64% to about 69% of the INI RT. At −30° C., at least some samples can be characterized as maintaining at least about 50% of their INI −30° C.

### EXAMPLE 3

The expected properties of a prophetic embodiment of a sample siloxane-containing composition as described herein (designated sample ‘R-1’), derived from test data from a large sample of compositions as described herein was compared to several compositions known to be commercially comparable (designated C-1, C-2, C-3 and C-4). Sample R and the associated predicted properties are the product of a mathematical modeling tool that makes use of experimental input data from the testing of actual samples like those of Example 2 to extrapolate additional embodiments having similar properties with a statistically reliable model. The composition constraints entered into the model were: Total polycarbonate, 48.7 wt. % to 69.0 wt. % with a melt viscosity rate of 10 cm³/10 min to 20 cm³/10 min per ASTM-1238; polycarbonate-polysiloxane copolymer, 0.0 wt. % to 20.1 wt. %; and bulk polymerized ABS, 24.8 wt. % to 39.0 wt. %. Sample R-1 would comprise 16.6 wt. % polycarbonate-polysiloxane copolymer, 26.4 wt. % bulk polymerized ABS and 57 wt. % polycarbonate, wherein the proposed polycarbonate-polysiloxane copolymer is an opaque linear polycarbonate polydimethylsiloxane (PC-PDMS) block-co-polymer containing 20 wt. % siloxane by weight of the copolymer, the bulk polymerized ABS contains a nominal 16 wt. % butadiene and a nominal 15 wt. % acrylonitrile content by weight of the bulk polymerized ABS and may have a phased inverted structure with occluded SAN in a butadiene phase in a SAN matrix, the polycarbonate is a bisphenol-A polycarbonate having a molecular weight of 18,000 g/mole to 40,000 g/mole (on an absolute PC molecular weight scale). In addition, sample R-1 would contain about 1.1 wt. % of additives including a mold release agent, a stabilizer and at least a primary antioxidant. Comparative samples C-1, C-3 and C-4 comprised polycarbonate and emulsion-based ABS. Sample C-2 comprised polycarbonate and bulk polymerized ABS. None of samples C-1, C-2, C-3 or C-4 contained polycarbonate-siloxane copolymer. All of the formulations all contained (or would contain) primary antioxidant and secondary antioxidants that are well known to those versed in the arts. The comparative samples were compared for carbon emissions, INI RT and INI at −30° C., −40° C., −50° C. and −60° C., melt viscosity, Vicat softening temperature and heat deflection temperature (HDT). The test results and the corresponding results expected from sample R-1 are set forth in Table 3A.

TABLE 3A

| | | Sample | Sample | Sample | Sample | Sample |
|---|---|---|---|---|---|---|
| | Unit | R-1 | C-1 | C-2 | C-3 | C-4 |
| Polycarbonate | | Yes | yes | Yes | Yes | yes |
| Bulk or Emulsion ABS | | Bulk | Emulsion | Bulk | Emulsion | Bulk |
| Polycarbonate- | | yes | no | No | No | no |
| polysiloxane copolymer | | | | | | |
| Property | | | | | | |
| C-emission | μg C/g | 15 | 23 | 21 | 24 | 24 |
| INI (RT) | kJ/m² | 57 | 46 | 63 | 54 | 56 |
| INI (−30° C.) | kJ/m² | 45 | 23 | 19 | 44 | 42 |
| INI (−40° C.) | kJ/m² | 43 | 21 | 17 | 23 | 23 |
| INI (−50° C.) | kJ/m² | 35 | 17 | 16 | 19 | 20 |
| INI (−60° C.) | kJ/m² | 29 | 14 | 12 | 16 | 18 |
| MV (260° C. at 1,000 1/s) | Pa · s | 226 | 239 | 192 | 239 | 258 |
| MV (260° C. at 1500 1/s) | Pa · s | 175 | 187 | 150 | 190 | 199 |
| MV (260 C at) 5000 1/s | Pa · s | 82 | 84 | 67 | 91 | 87 |
| MV (260 C at 1,0000 1/s) | Pa · s | 50 | 54 | 41 | 58 | 52 |
| Vicat B/50 | ° C. | 125.3 | 123.4 | 114.1 | 125.6 | 126.7 |
| HDT | ° C. | 102.5 | 103.8 | 97.1 | 105.4 | 104.8 |

The data of Table 3A clearly shows the excellent expected impact/flow balance of sample R-1 in combination with the required heat properties. The INI values are extremely high, especially at low temperature, and significantly higher than the comparative materials at −40° C., −50° C. and −60° C. In addition, test data indicate that sample R-1 would be more ductile than the comparative samples, exhibiting ductile failure in INI trials with 25 kJ/m² at about −60° C., whereas the comparative samples do not exhibit ductile failures below about 20° C.

The aging properties of the comparative compositions and the expected aging properties of sample R-1 are shown in Table 3B below.

TABLE 3B

| | | | | |
|---|---|---|---|---|
| Sample | Sample | Sample | Sample | Sample |
| R-1 | C-1 | C-2 | C-3 | C-4 |

Retention of value (%) after Heat Aging 1,000 hrs,
100° C. @ 1-2% RH

| | | | | | |
|---|---|---|---|---|---|
| INI RT | 89 | 45 | 51 | 72 | 69 |
| INI −30° C. | 81 | 34 | 40 | 38 | 42 |
| PC Mw | 99 | 92 | 100 | 93 | 100 |

Retention of value (%) after Hydrolytic Aging 1,000 hrs,
90° C. @ 95% RH

| | | | | | |
|---|---|---|---|---|---|
| INI RT | 62 | 5 | 61 | 5 | 71 |
| INI −30° C. | 48 | 10 | 76 | 7 | 40 |
| PC Mw | 86 | 39 | 92 | 31 | 93 |

Table 3B illustrates that sample R would have significantly better retention of INI RT and INI −30° C. impact strength after thermal aging relative to samples C-1, C-2, C-3 and C-4.

As is evident from the data in the examples, a composition as described here may be molded into a 4-mm thick molded INI bar that maintains more than 65% of its notched Izod impact strength determined at room temperature after thermal aging of one thousand hours at 90° C. at 95% relative humidity. Similarly, such a composition may be molded into a 4-mm thick molded INI bar that maintains about 59% to about 69% of its notched Izod impact strength determined at room temperature after hydrolytic aging (one thousand hours at 90° C. at 95% relative humidity), or into a 4-mm thick molded INI bar that maintains more than 40% of its notched Izod impact strength determined at −30° C. after hydrolytic aging or, in another embodiment, into a 4-mm thick molded INI bar that maintains at least about 50% of its notched Izod impact strength determined at −30° C. after hydrolytic aging. In various embodiments, a composition as described herein may be molded into a 4-mm thick molded INI bar having, prior to aging, a notched Izod impact strength of about 40 kJ/m² to about 80 kJ/m² determined in accordance with ISO 180/1A at −40° C. or, optionally, a notched Izod impact strength of about 26 kJ/m² to about 70 kJ/m² at −50° C. or, optionally, a notched Izod impact strength of about 23 kJ/m² to about 60 kJ/m² or, in a specific embodiment, about 23 kJ/m² to about 40 kJ/m² determined at −60° C.

### EXAMPLE 4

Several additional possible formulations of compositions as described herein, a possible comparative composition (R-4), and their expected properties, are set forth in Table 4A and Table 4B, respectively.

TABLE 4A

| | Sample | | | | |
|---|---|---|---|---|---|
| | R-2 | R-3 | R-4 | R-5 | R-6 |
| PC EXL | 16.6 | 20.1 | 0.0 | 19.3 | 20.1 |
| BABS | 26.4 | 24.8 | 39.0 | 25.0 | 24.8 |
| PC-2 | 10.2 | 26.3 | 40.1 | 36.7 | 36.3 |
| PC-1 | 46.8 | 28.8 | 20.9 | 19.0 | 18.8 |

TABLE 4B
Projected Test Results

| | | | | | |
|---|---|---|---|---|---|
| C-Emissions (μg C/g) | 15 | 15 | 19 | 15 | 15 |
| INI RT (kJ/m²) | 57 | 61 | 59 | 63 | 63 |
| INI −30° C. (kJ/m²) | 45 | 52 | 47 | 54 | 54 |
| INI −40° C. (kJ/m²) | 43 | 54 | 34 | 56 | 57 |
| INI −50° C. (kJ/m²) | 35 | 49 | 23 | 51 | 53 |
| INI −60° C. (kJ/m²) | 29 | 35 | 22 | 36 | 36 |
| MV @ 260° C. | | | | | |
| (Pa · s) | | | | | |
| @1,000/s | 226 | 244 | 175 | 248 | 249 |
| @1,500/s | 175 | 187 | 150 | 190 | 198 |
| @5,000/s | 82 | 87 | 71 | 87 | 88 |
| @10,000/s | 51 | 53 | 44 | 54 | 55 |
| Vicat B/50 | 125.3 | 125.8 | 119.3 | 125.9 | 125.8 |
| (° C.) | | | | | |
| HDT A/e | 102.5 | 103.7 | 97.5 | 104.0 | 104.1 |
| (° C.) 1.8 | | | | | |

% Retention of property after thermal aging 1000 hr @110° C.

| | | | | | |
|---|---|---|---|---|---|
| INI RT | 89 | 91 | 78 | 91 | 91 |
| INI −30° C. | 81 | 81 | 73 | 81 | 81 |
| PC mol.wt. | 99 | 99 | 100 | 99 | 99 |

Retention of property after hydrolytic aging 1000 hr @ 90° C./95% RH

| | | | | | |
|---|---|---|---|---|---|
| INI RT | 62 | 69 | 63 | 72 | 72 |
| INI −30° C. | 48 | 50 | 38 | 50 | 50 |
| PC mol.wt. | 86 | 84 | 83 | 83 | 83 |

The combination of excellent hydrolytic aging, excellent heat aging, and processability of the above compositions containing BABS, polycarbonate and polycarbonate-polysiloxane copolymer is unique. The compositions further have very good physical properties, including good impact strength at ambient temperature and at low temperature. The compositions are therefore highly useful in the manufacture of articles such as automobile components. The foregoing examples demonstrate that compositions described herein achieve a surprising improvement in the combination of flow properties and impact resistance and, in some cases superior aging properties, relative to other compositions. For example, a comparison of sample F (Example 2) with sample C-2 (Example 3) shows that sample F has a comparable flow characteristic (MV) but superior impact resistance at low temperature; a similar comparison can be made between sample K and samples C-1 and C-3. On the other hand, sample C-4 has hydrolytic aging properties comparable to the compositions described herein but relatively poor flow characteristics and low temperature impact resistance. Also, compositions described herein have low temperature ductile/brittle transition temperatures.

As used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). All ranges disclosed herein for the same property or amount are inclusive of the endpoints and independently combinable. All cited patents, patent applications, and other references are incorporated herein by reference in their entirety.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thermoplastic composition, comprising:
a polycarbonate resin;
bulk polymerized ABS; and
a polycarbonate-polysiloxane copolymer;
wherein a 4-mm thick molded INI bar comprising the composition has an initial (before aging) notched Izod impact strength of at least about 36 kJ/m² determined in accordance with ISO 180/1A at −40° C.

2. The composition of claim 1 wherein the polycarbonate-polysiloxane copolymer comprises at least about 1 weight percent of dimethylsiloxane, or a molar equivalent amount of another polydiorganosiloxane, based on the combined weight of the polycarbonate, bulk polymerized ABS, and polycarbonate-polysiloxane copolymer.

3. The composition of claim 1 having a melt viscosity of less than 210 Pa·s at 1500/s shear rate at 260° C. per DIN-54811.

4. The composition of claim 1 having a melt viscosity of less than 190 Pa·s at 1500/s shear rate at 260° C. per DIN-54811.

5. The composition of claim 1, wherein a flat, 4 mm thick molded tensile bar formed from the composition has a Heat Deflection Test (HDT) temperature of more than 100° C., determined at 1.8 MPa per ISO 75Ae.

6. The composition of claim 1, wherein a 4-mm thick molded INI bar comprising the composition maintains more than 40% of its notched Izod impact strength determined at −30° C. after aging of one thousand hours at 90° C. at 95% relative humidity (90° C./95% RH).

7. The composition of claim 1, wherein a 4-mm thick molded INI bar comprising the composition maintains at least about 50% of its notched Izod impact strength determined at −30° C. after aging of one thousand hours at 90° C./95% RH.

8. The composition of claim 1, wherein a 4-mm thick molded INI bar comprising the composition maintains more than 83% of its notched Izod impact strength determined at room temperature after thermal aging of one thousand hours at 110° C.

9. The composition of claim 1, wherein a slurry of the composition comprising 1 gram of the composition in 10 ml of water has a pH of about 4 to about 8.

10. The composition of claim 1, wherein a slurry of the composition comprising 1 gram of the composition in 10 ml of water has a pH of about 5 to about 7.

11. The composition of claim 1, wherein slurries of individual components of the composition comprising 1 gram of a single polymeric component in 10 ml of water each have a pH of about 4 to about 8.

12. The composition of claim 1, wherein slurries of individual components of the composition comprising 1 gram of a single polymeric component in 10 ml of water each have a pH of about 5 to about 7.

13. The composition of claim 1, having a percent change in weight average molecular weight after aging at 90° C./95% RH of less than about 20%, wherein the weight average molecular weight is measured by gel permeation chromatography in dichloromethane using polystyrene standards.

14. The composition of claim 1, wherein the composition is substantially free of materials that would catalyze hydrolysis of the polycarbonate resin, bulk polymerized ABS or polycarbonate-polysiloxane.

15. The composition of claim 1, further comprising a stabilizer that does not catalyze hydrolysis of the polycarbonate resin, bulk polymerized ABS or polycarbonate-polysiloxane copolymer.

16. The composition of claim 1, wherein the composition is substantially free of hydrolytically unstable phosphites.

17. The composition of claim 1, wherein the composition is substantially free of substances which form materials that would generate degradation catalysts in the presences of moisture.

18. The composition of claim 1, comprising:
about 40 wt. % to about 75 wt. % polycarbonate resin;
about 10 wt. % to about 40 wt. % bulk polymerized ABS; and
about 1 wt. % to about 50 wt. % polycarbonate-polysiloxane copolymer, each based on the total combined weight of polycarbonate resin, bulk polymerized ABS, and polycarbonate-polysiloxane copolymer.

19. The composition of claim 18, wherein the polycarbonate-polysiloxane copolymer comprises about 3 wt. % to about 40 wt. % dimethylsiloxane, or a molar equivalent amount of another diorganosiloxane, based on the weight of the copolymer.

20. The composition of claim 18, wherein the bulk polymerized ABS comprises about 20 wt. % to about 35 wt. % butadiene and about 12 wt. % to about 35 wt. % acrylonitrile based on the weight of the bulk polymerized ABS.

21. The composition of claim 18, comprising about 10 wt. % to about 20 wt. % of polycarbonate-polysiloxane copolymer, based on the combined weight of polycarbonate-polysiloxane resin, the bulk polymerized ABS and the polycarbonate.

22. The composition of claim 18, comprising about 20 wt. % to about 35 wt. % of the bulk polymerized ABS, based on the combined weight of polycarbonate-polysiloxane resin, the bulk polymerized ABS and the polycarbonate.

23. The composition of claim 18, wherein the polycarbonate-polysiloxane copolymer comprises at least about 1 weight percent of dimethylsiloxane, or a molar equivalent of another diorganosiloxane, based on the combined weight of polycarbonate-polysiloxane copolymer, bulk polymerized ABS, and polycarbonate.

24. The composition of claim 1, wherein the polycarbonate-polysiloxane copolymer comprises siloxane structural units of the of formula 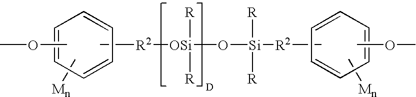
wherein each occurrence of R is same or different, and is a C₁₋₁₃ monovalent organic radical and the value of D is 2 to about 1,000, and wherein R² is a divalent C₂-C₈ aliphatic group, and wherein each M may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, and wherein each n is independently 0, 1, 2, 3, or 4.

25. The composition of claim 18, wherein the polycarbonate-polysiloxane copolymer comprises siloxane structural units of the of formula 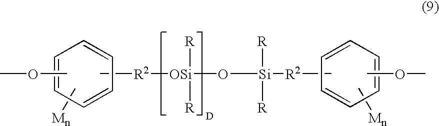
wherein each occurrence of R is same or different, and is a C₁₋₁₃ monovalent organic radical and the value of D is 2 to about 1,000, and wherein R² is a divalent C₂-C₈ aliphatic group, and wherein each M may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, and wherein each n is independently 0, 1, 2, 3, or 4.

26. An article comprising the composition of claim 1.

27. A method for forming an article, comprising molding, shaping or forming the composition of claim 1 to form the article.
